(19) United States
(12) Patent Application Publication
(10) Pub. No.: US 2021/0017440 A1
(43) Pub. Date: Jan. 21, 2021

(54) LATEX CHEMISTRY WITH COALESCING AGENT

(71) Applicant: Schlumberger Norge AS, Stavanger (NO)

(72) Inventor: Anders Grinrod, Sandnes (NO)

(21) Appl. No.: 16/978,096

(22) PCT Filed: Mar. 6, 2019
(86) PCT No.: PCT/US2019/020858

§ 371 Date: Sep. 3, 2020

Related U.S. Application Data
(60) Provisional application No. 62/639,331, filed on Mar. 6, 2018.

(51) Int. Cl. C09K 8/12; C09K 8/508; E21B 21/00; E21B 33/138

(52) U.S. Cl. CPC C09K 8/12; C09K 8/5083; C09K 2208/08; E21B 21/00; E21B 33/138; C09K 8/5086

(57) ABSTRACT

A wellbore fluid may include an aqueous base fluid, a plurality of latex particles and a coalescing agent present in the fluid in an amount effective to have an effect on decreasing the activation temperature of the latex. A method may include emplacing a wellbore fluid into a wellbore through an earthen formation, the wellbore fluid may include an aqueous base fluid, a plurality of latex particles and a coalescing agent present in the fluid in an amount effective to have an effect on decreasing the activation temperature of the latex.

This application is related to U.S. Patent Application No. 62/639,331, filed on Mar. 8, 2018, which is herein incorporated by reference in its entirety.

### BACKGROUND

During the drilling of a wellbore, various fluids are used in the well for a variety of functions. The fluids may be circulated through a drill pipe and drill bit into the wellbore, and then may subsequently flow upward through wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure, to prevent the ingress of formation fluids into the wellbore, to cool and lubricate the drill string and bit, and/or to maximize penetration rate.

However, for a wellbore fluid to perform all of its functions and allow wellbore operations to continue, the fluid must stay in the borehole. Frequently, undesirable formation conditions are encountered in which wellbore fluids may be lost to the formation. For example, wellbore fluids may leave the borehole through large or small fissures or fractures in the formation or through a highly porous rock matrix surrounding the borehole. Thus, fluid loss or lost circulation is a recurring drilling problem, characterized by loss of wellbore fluids into downhole formations that are fractured, highly permeable, porous, cavernous, or vugular. Other problems encountered while drilling and producing oil and gas include stuck pipe, hole collapse, loss of well control, and loss of or decrease in production.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a wellbore fluid that includes an aqueous base fluid; a plurality of latex particles; and a coalescing agent present in the fluid in an amount effective to have an effect on decreasing the activation temperature of the latex.

In another aspect, embodiments of the present disclosure relate to a method that includes emplacing a wellbore fluid into a wellbore through an earthen formation, the wellbore fluid including an aqueous base fluid; a plurality of latex particles; and a coalescing agent present in the fluid in an amount effective to have an effect on decreasing the activation temperature of the latex.

Other aspects and advantages of the claimed subject matter will be apparent from the following description and the appended claims.

### BRIEF DESCRIPTION OF DRAWINGS

FIG. 1 illustrates a schematic diagram of the Shale Membrane Test (SMT) apparatus, according to the present embodiments.

FIG. 2 illustrates disc adhesion strength test results, according to the present embodiments.

FIG. 3 illustrates SMT data, according to the present embodiments.

### DETAILED DESCRIPTION

Generally, embodiments disclosed herein relate to wellbore fluids and methods of using the same. More specifically, embodiments disclosed herein relate to wellbore fluids for downhole applications formed of an aqueous base fluid, a plurality of latex particles and a coalescing agent. The inventor of the present disclosure has found that the addition of a coalescing agent to wellbore fluids that include a plurality of latex particles may decrease the activation temperature and the adherence of the latex in the absence of a heat activation temperature.

According to the present embodiments, the wellbore fluids of the present disclosure may contain latex polymers that may aid in controlling fluid loss and strengthen unconsolidated or poorly consolidated sections in a wellbore. The latex polymers as disclosed herein may combat borehole instability and increase risks of collapse that may occur when operating in fracture prone formations including shale, or in unconsolidated formations. Wellbore strengthening may minimize or reduce the risk of lost fluid circulation and may be used to improve zonal isolations and sealing applications.

As defined herein, latex is a stable dispersion (emulsion) of polymeric microparticles in an aqueous medium. Traditional synthetic latex products are made by polymerizing monomers that have been emulsified with surfactants. According to the present embodiments, the latex polymers of the present disclosure may be delivered in a liquid form, as an emulsion. Upon filtration, the latex particles coalesce to form a film/structure in the filter cake or in the micro-fractures. In one or more embodiments, the latex polymers of the present disclosure may have a particle size distribution d₅₀ of less than 1500μ. According to various embodiments, the latex polymers as described herein may be present in sufficient concentration to provide wellbore consolidation downhole. Generally, the latex polymers of the present disclosure may be added to a wellbore fluid in a concentration of at least 100 g/l.

According to various embodiments, latexes may be derived from polymers prepared from a varied selection of monomers including aromatics, acrylates and methacrylates, and amine monomers. Latexes in accordance with the present disclosure may be prepared from homopolymers, copolymers and higher order polymers such as ter-polymers, quater-polymers, and the like.

Monomers may include aromatic species including styrenes such as o-, m-, and p-methyl styrenes, o-, m-, and p-ethylstyrenes, 2,4-dimethylstyrene, 2,4-di-ethylstyrene, 2-methyl-4-ethylstyrene, alpha-methylstyrene, alpha-ethyl styrene, alpha-methyl-Z-methylstyrene, alpha-methyl-4-methyl styrene, alpha-methyl-2,4-dimethyl styrene and the like. Latex polymers may also include acrylate and methacrylates, and alkyl esters of acrylic and methacrylic acids. Amine monomers in accordance with the present disclosure may include amino derivatives of lower alkyl acrylic or methacrylic monomers such as alkyl acrylamides and methacrylamides, and aliphatic amino alkyl methacrylates and acrylates such as 2-(dimethylamino)-ethyl acrylate or methacrylate, N-tert-butyl-2-aminoethyl methacrylate, amine substituted styrenes such as 4-vinyl-benzylamine and 4-vinyl aniline, and similar vinyl amine species. Other possible monomers that may be incorporated into latex polymers may include vinyl esters of fatty acids, acrylonitrile, styrene, vinyl chloride, vinylidene chloride, tetrafluoroethylene and other mono-olefinically unsaturated monomers. In some embodiments latexes may be prepared from polymers that include alkyl-acrylate-co-acetate, polyhydroxyalkanoate, polyvinyl acetate, styrene acrylate amine terpolymers, styrene-co-acrylates, styrene acrylate methacrylate terpolymers, and styrene-co-amine polymers. Particular latex polymers used in the wellbore fluids of the present disclosure are selected from the group of alkyl-acrylate-co-acetate, styrene acrylate amine terpolymer, styrene-co-acrylate, styrene acrylate methacrylate terpolymer and styrene-co-amine polymer, polyhydroxyalkanoate, natural latex, starches and polyvinyl acetate.

According to various embodiments, the latex polymers of the present disclosure may be dispersed in an aqueous base fluid. The latex polymers of the present disclosure may act as a wellbore stabilization agent, enhancing wellbore consolidation downhole. For example, as noted above, they may generate a filter cake on the walls of a wellbore that prevents or reduces fluid flow in or out of the wellbore, and increases the mechanical stability of the near-wellbore formation in treated intervals. Reinforced filter cakes may prevent damage that occurs for example during drilling operations such as when passing a drill string through narrow boreholes, and may mitigate the risk of pack-offs occurring while removing drill strings and other equipment.

The latex polymers as described herein may show strong adherence to formations and may generate a filter cake on the walls of a wellbore that prevents or reduces fluid flow in or out of the wellbore, and increases the mechanical stability of the near-wellbore formation in treated intervals. Latex polymers in accordance with the present disclosure may have fracture filling and gluing properties, without adversely affecting mud rheology.

According to various embodiments, the wellbore stabilizing chemistry using latex polymers as described herein may exhibit the following properties and effects: a) minimization of losses in fractured formations; b) hydraulic blocking of micro-fractured shale; c) provision of a mechanically strong filter cake in permeable formations; d) good adhesion of filter cake to permeable formation; e) reduction in borehole collapse potential, particularly upon POOH (pulling out of hole); f) continuously present in the drilling fluid during circulation; g) good temperature stability, withstands exposure to elevated temperatures; h) no negative effect on drilling fluid properties.

Without being bound by the theory, the inventor of the present disclosure believes that the latex particles may activate to form a filter cake due to the temperature and filtration, without having any cohesive/gluing effect in bulk fluid. However, to reduce the risk of cured sealant in the bulk fluid, the selected chemistry may activate and deposit as a function of filtration, and not exclusively by temperature alone. The activation and adherence of the latex is similar prior and after hot rolling at a maximum temperature of 100° C., hence pre-activation should not be an issue. In fact, as described later in greater detail, systematic studies performed on various latexes indicate that the factors that determine a proper adhesion are: 1) the particle size distribution of the latex particles, 2) the monomers used for the preparation of the latex and 3) the coalescing agent used. According to the present disclosure, the latex polymers as described herein may activate and adhere at temperatures ranging from about 25° C. to about 100° C. in the absence of a heat activation tool.

According to various embodiments, the wellbore fluids of the present disclosure may include a coalescing agent which may provide film forming properties at lower temperatures. For example, the latex polymers as described herein may be combined with a coalescing agent, to create a composition that interacts synergistically to form a filter cake that exhibits increased adherence to the formation. Reinforced filter cakes may prevent damage that occurs during drilling operations such as when passing a drill string through narrow boreholes, and may mitigate the risk of pack-offs occurring while removing drill strings and other equipment. Furthermore, it has been found by the inventor of the present disclosure that the addition of the coalescing agent may decrease the activation temperature of the latex. Selection of a coalescing agent may be based on its stability in water, as well as its compatibility with the latex polymer without adversely affecting the colloidal stability of the latex.

Thus, the choice of a specific coalescing agent for a particular latex will depend upon the nature of the latex and the desired use of the latex. Generally, the amount of a coalescing agent that may be used depends upon the nature of the latex polymer (especially its glass transition and minimum film forming temperatures and hardness) and the end use of the latex. According to the present embodiments, the coalescing agent is present in the wellbore fluid in an amount effective to have an effect on decreasing the activation temperature of the latex. For example, in one or more embodiments, the coalescing agent may be present in the wellbore fluid in a concentration that ranges from about 1.0 g/l to about 30 g/l, where the lower limit can be any of 1.0 g/l, 2.5 g/l, or 5.0 g/l and the upper limit can be any of 20 g/l, 25 g/l or 30 g/l, where any lower limit can be used with any upper limit.

In one or more embodiments, the coalescing agent may be selected from the group of polyols. For example, in one embodiment, the polyols may be selected from the group of glycerides, triglycerides and alcohols. In various embodiments, polyols that do not have a long chain may be used. It is also envisioned that the coalescing agents may be selected from the group of polyol esters. According to the present embodiments, all, some or one of the alcohol groups on the polyol may be esterified. In various embodiments, the polyol esters may have a low molecular weight to avoid diffusion of the ester in the latex polymer. The polyol esters that have shown utility in the present disclosure may have a molecular weight of up to 12,000. For example, in one embodiment, the coalescing agent is tributyrin (tributyl ester of glycerol). In such embodiment, the synergism between a latex polymer and tributyrin may result in a high potential for formation stabilization. Other polyol esters that may be used include, but are not limited to, triacetin, triethylcitrate, bis (2-ethyl hexyl adipate) or dibutylsebacate.

It is also envisioned that fibers may be added to the wellbore fluids of the present disclosure. The addition of the fibers creates a filtration network such that the latex may concentrate and coalesce. To achieve acceptable adherence of a filter cake towards porous media, the minimum concentration of the latex is 100 g/l in 1.5 s.g. (specific gravity) water base mud (WBM). In one or more embodiments, the fibers may be selected from glass fibers and carbon fibers. However, it is envisioned that other types of fibers, or fibers having various sizes may be used.

Latexes may also include one or more surfactants known in the art. Latexes may be hydrophobic in nature and may tend to form discrete particles in aqueous solutions to minimize interaction with water. Surfactants may be added in some embodiments to stabilize the polymer in solution and to improve the interaction of the polymer with aqueous fluids. Surfactants in accordance with the present disclosure may include, for example, anionic and/or nonionic surfactants that may stabilize the latex-containing copolymer by electrostatic repulsion or steric stabilization, respectively.

Suitable anionic surfactants that may be used include the fatty alcohol sulfates such as the sulfates of alcohols having from 8 to 18 carbon atoms such as sodium lauryl sulfate, ethoxylated fatty alcohol sulfates, sulfonated alkyl aryl compounds such as sodium dodecylbenzene sulfonate, and fatty acids having 8 to 18 carbon atoms. Examples of nonionic surfactants include alkylphenoxypolyethoxyethanols having alkyl groups of about 7 to 18 carbon atoms and about 9 to 40 or more oxyethylene units such as octylphenoxypolyethoxyethanols, dodecylphenoxypolyethoxyethanols; ethylene oxide derivatives of long-chain carboxylic acids, such as lauric, myristic, palmitic, and oleic acids; ethylene oxide condensates of long-chain alcohols such as lauryl or cetyl alcohol, and the like. In one or more embodiments, surfactants may be used in an amount ranging from 0.2 to 5 weight percent of the wellbore fluid (wt %).

One of the optional components of the wellbore fluids of this disclosure is a plasticizer which may be added to the wellbore fluid to reduce the modulus of the polymer at the use temperature by lowering its glass transition temperature (Tg). This may allow control of the viscosity and mechanical properties of the composition. For example, wellbore fluids of the present disclosure may include an acetic acid derivative plasticizer, such as for example triacetin. Other plasticizers may include a citric acid derivative plasticizer, wherein at least one of the carboxylic acid functional groups of the citric acid nucleus is esterified with a C₁ to C₁₂ alcohol, and wherein the hydroxyl group of the citric acid nucleus is unfunctionalized or esterified with a C₁ to C₁₂ carboxylic acid. In some embodiments, citric acid derivative plasticizers may include tributyl citrate esters, acetyl-tri-n-hexyl citrate, acetyl-tri-n-hexyl citrate, acetyl-tri-n-octyl citrate, acetyl-tri-n-decyl citrate, acetyl tributyl citrate, acetyl trihexyl citrate, butyryl trihexyl citrate esters. It is also envisioned that other conventional plasticizers may be used depending on the application and environmental requirements, for example.

As noted above, wellbore fluids may be formulated by dispersing the latex particles of the present disclosure in an aqueous base fluid. In various embodiments, the aqueous base fluid may generally be any water base fluid phase. In one or more embodiments, the aqueous base fluid may be selected from fresh water, sea water, brines (e.g., a saturated salt water or formation brine), mixtures of water or brine and water-soluble organic compounds, or mixtures thereof. In those embodiments of the disclosure where the aqueous medium is a brine, the brine may include water and an inorganic salt or an organic salt. The salt may serve to provide a portion of the fluid's density (to balance against the formation pressures), and may also reduce the effect of the water based fluid on hydratable clays and shales encountered during completion. In various embodiments, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution.

The wellbore fluids of the present disclosure may also include additional components, such as weighting agents, fluid loss control agents, bridging agents, lubricants, penetration rate enhancers, defoamers, anti-bit balling agents, corrosion inhibition agents, surfactants, viscosifiers, inhibitors (such as accretion inhibitors) and suspending agents and the like. Such compounds should be known to one of ordinary skill in the art of formulating wellbore fluids.

Upon mixing, the fluids of the present embodiments may be used in wellbore operations, such as drilling operations when the wellbore fluid is a drilling fluid. Such operations are known to persons skilled in the art and involve pumping a drilling fluid into a wellbore through an earthen formation. The fluids of the present embodiments may have particular application for enhanced wellbore consolidation downhole. In addition, as noted above, such fluids are stable.

One embodiment of the present disclosure includes a method that involves emplacing a wellbore fluid into a wellbore through an earthen formation. In a particular embodiment, the wellbore fluid may incorporate an aqueous base fluid, a plurality of latex particles and a coalescing agent present in the fluid in an amount effective to have an effect on decreasing the activation temperature of the latex. Such wellbore operations may include, but are not limited to drilling.

Upon introducing a wellbore fluid of the present disclosure into a borehole, a filter cake may be formed which provides an effective sealing layer on the walls of the borehole preventing undesired invasion of fluid into the formation through which the borehole is drilled. Filter cakes formed from wellbore fluids disclosed herein may exhibit properties such as pressure blockage, reliability of blockage, and increased range of formation pore size that can be blocked.

Where the formation is a low permeability formation such as shales or clays, the filter cakes formed using the wellbore fluids and methods of the present disclosure prevent wellbore fluid and filtrate loss by effectively blocking at least some of the pores of the low permeation formation. This may allow for support of the formation by maintaining sufficient pressure differential between the wellbore fluid column and the pores of the wellbore. Further, the filter cakes formed by wellbore fluids of the present disclosure may effectively seal earthen formations, and may be stable at elevated temperatures.

### EXAMPLES

The following examples are presented to further illustrate the properties of various wellbore fluids formulated with a plurality of latex particles and a coalescing agent in accordance with the present disclosure, and should not be construed to limit the scope of the disclosure, unless otherwise expressly indicated in the appended claims.

Specifically, fluid formulations according to the present disclosure were tested according to the following: a) viscosity before heat rolling (BHR) and at 0, 20, 50 and 80° C. after heat rolling (AHR) for 16 hours; b) API and HTHP fluid loss control; c) adherence of filter cake towards ceramic 10 micron disc; d) inhibition testing towards highly dispersive clay (accretion, cuttings hardness and dispersion); e) foam/trapped air measurement; f) contamination tolerance towards cement, seawater and drill solids; g) static sag stability after 1 and 3 days; h) pH. Some of the methods used for testing were according to API recommended practice, and other methods were developed particularly for evaluating a specific property of a product. The test temperature was set to 100° C. for the initial part of the project. For the concept validation phase the testing was performed AHR at temperatures of 40° C. and 80° C.

Filtration

The HTHP Filter Press testing is used for screening products with respect to reducing fluid loss, and to evaluate the quality and the mechanical property of the filter cake. Filtration is considered a principal activation mechanism in permeable formations, and therefore the screening was largely based on this test method.

Low pressure is assumed to be the worst case scenario for filter cake deposition, as higher pressure is assumed to yield increased transport of particles into pores and fractures. The lowest over pressure for the applications is estimated to 500 psi, hence 500 psi is recommended as a differential pressure for filtration tests. To accommodate various types of formations, inert media like ceramic discs are selected as filtration media. The 10 μm disc is the lowest pore size available. According to the well conditions of the selected applications, the HTHP Filter Press test conditions were: ceramic disc: 10 μm (old designation: 3 μm); differential pressure: 500 psi; temperature: 100° C.; test period: 2 hours.

Manual Scratch Test

The test allows for simple and fast screening of the PHA latex based sealants gluing and strengthening effects of the filter cake. The filter cake is produced according to standard HTHP filter press procedure. For evaluation at elevated temperatures, the hot HTHP filter cell is disassembled immediately after the filtration time ends. The filter cake is qualitatively evaluated based on its adherence to the disc of the cake when scratching it off the disc with a small spatula. The adherence of the filter cake is graded according to the criteria in Table 1.

TABLE 1
Adherence of filter cake
Cake Adherence

| | |
|---|---|
| No adherence | 0 |
| Low adherence | 1 |
| Medium adherence | 2 |
| Strong adherence | 3 |
| Very strong. | 4 |
| Non removable film | |

Disc Adhesion Strength Test (DAST)

The Disc Adhesion Test (DAST) is an in-house developed method for the evaluation of the adhesive properties of the filter cake towards various media, such as sandstone, shale and other materials. Good adhesive properties of the filter cake are thought to be particularly relevant where pressure fluctuations are encountered such as in a POOH (pulling out of hole) situation. The DAST test is based on the amount of force that may pull off a piece of rock that is placed on top of a filter cake. The test is carried out according to a three stage procedure: firstly, a standard HTHP filtration of the relevant fluid is carried out to build a filter cake on a disc; secondly, the HTHP cell is opened and a disc shaped piece of the relevant material is placed on top of the filter cake and further filtration is carried out. Thirdly, the cell is removed from the heating jacket and placed in a custom-made apparatus for measuring the force needed to remove the disc from the filter cake. The pull force is applied in a direction normal to the plane of the filter cake.

Fracture Slot Test

The Fracture Slot Test is a test used for evaluation of plugging and sealing compared to standard testing on slotted steel discs. The test was performed to evaluate latex polymers used as sealing additives, as described herein, with LCM plugging materials for fractures of various widths (200 μm-2000 μm). The test relies on filtration from wellbore to formation direction from 30 minutes up to 2 hours at temperature from 25 to 100° C. No fracture filing properties were observed in the initial test data due to issues with the fracture slot design.

Fracture Adhesion Test

The fracture adhesion test is an initial simple and fast screening of cohesive strength in fractures or loose formation fragments. The clay chippings (various types) react when subjected to the fluid and form a 5 mm pack towards the disc. This makes it difficult to differential effect of sealant. However, the latex glues stacks of two discs (various types) when the lower disc is permeable and a filtercake is formed between them. The results (not shown) indicate that there is gluing effect in small fractures if the fluid is filtrated.

Shale Membrane Test (SMT)

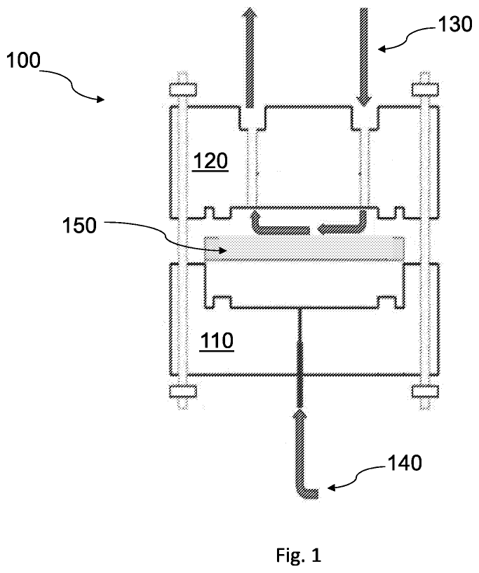

Generally, the SMT evaluates the efficiency of a compound in sealing a micro-fractured shale. A schematic diagram of the used SMT apparatus is shown in FIG. 1. The parameter that is measured is pressure transmission over a piece of shale sample 150. The shale sample 150 is molded into an epoxy potting compound and subsequently sliced to expose the shale surface. The thickness of the shale sample 150 is typically ¼ in and its geometry is quadratic (1 inch on the sides). The epoxy embedded shale sample is thereby placed into a cell 100, where the test fluid 130 is flowed on the top of the sample at a controlled rate and pressure (300 psi). The cell 100 has a base 110 and a top cap 120. The sample 150 is also pressurized on the bottom side as indicated by 140. Differential pressure is typically 250 psi. The current testing is carried out at ambient temperature conditions. The bottom pressure (50 psi) is recorded, and the pressure versus time profile (not shown) is recorded. A completely blocked shale sample may show no change of the bottom pressure over time, but typically bottom pressure may increase over time until equilibrium is reached. The time it takes before pressure equilibration happens, may be used as a measurement of the sealing properties of the fluid in question. The SMT was used to assess the effects of the latex polymers as described herein in terms of their abilities to block micro fractures in shale and stopping water ingress, thereby retaining wellbore stability in shale formations.

Initial studies were performed using two latexes, namely latex C1 and latex B. Latex B is styrene/acrylate latex, while latex C1 is latex B mixed with a coalescing agent. Table 2 below shows a comparison analysis of the filter cake adherence of latex B and latex C1. As seen from Table 2, the addition of the coalescing agent to the styrene/acrylate latex lowers the activation temperature of the latex.

TABLE 2
Filter cake adherence of latex B vs. latex C1

| | Filter cake | Latex B | Latex C1 |
|---|---|---|---|
| HTHP | Evaluation | Styrene/ | Latex B + coalescing |
| temperature | temperature | acrylate | agent |
| 25° C. | 25° C. | | Medium/strong |
| 40° C. | 40° C. | | Medium/strong |
| 60° C. | 60° C. | Low/medium | Medium/strong |
| 80° C. | 80° C. | | Medium/strong |
| 100° C. | 100° C. | Strong | Strong |
| 100° C. | 25° C. | Very strong | Very strong |

Specifically, as shown above in Table 2, latex B necessitates a heat activation tool for optimum adherence performance, while latex C1 will mostly not necessitate a heat activation tool. In fact, latex C1 activates and obtains medium to strong adhesion at temperatures from 25° C. to 100° C. It was also noticed that latex C1 achieves similar adherence before and after hot rolling. In addition, latex C1 achieves low accretion values at ambient and elevated temperatures (15-17%).

Next, two potential water based fluid systems for inclusion of the latex polymers as described herein were formulated, namely EMS-3100 and EMS-3360. The initial fluid formulations are summarized in Tables 3 and 4 below, the components of which are all available from M-I LLC (Houston, Tex.).

TABLE 3
1.5 s.g. EMS-3100

| | | Conc. |
|---|---|---|
| Product | Function | g/l |
| NaCl brine 1.20 s.g. | Base fluid | 887 |
| Kla-Hib NS | Inhibitor | 80 |
| Trol FL | FL agent | 15 |
| Duovis Plus NS | Viscosifier | 2.5 |
| Barite | Weight material | 440 |
| EMI-2223 | Anti-accrete | 73 |

TABLE 4
1.5 s.g. EMS-3360

| | | Conc. |
|---|---|---|
| Product | Function | g/l |
| NaCl brine 1.20 s.g. | Base fluid | 980 |
| EMI-3192 | Inhibitor | 40 |
| Trol Fl | FL agent | 4 |
| EMI-3172 | Encapsulator | 8.6 |
| Duovis Plus NS | Viscosifier | 1 |
| Barite | Weight material | 441 |
| EMI-1913 | Anti-accrete | 25 |

Various wellbore fluid formulations were prepared using the two water based fluid systems, namely, EMS-3100 and EMS-3360, latex C1 and a low concentration of a nonionic surfactant. Addition of the coalescing agent to the styrene/acrylate latex, as noted above, improves the filter cake adhesion at lower temperatures, hence a heat activation tool is not desired. The rheological properties of the formulations were studied. Table 5 below shows a comparison of rheological properties EMS-3360 and EMS-3100 in 1.10 s.g. NaCl brine.

TABLE 5
Comparison analysis of rheological
properties of EMS-3100 and EMS-3360

| System | | EMS-3100 1.5 s.g. | | | EMS-3360 1.5 s.g. | | | |
|---|---|---|---|---|---|---|---|---|
| Latex | g/l | — | 100 | 150 | — | 100 | 150 | 150 |
| HPC | g/l | — | — | 100 | — | — | — | 100 |
| 600 rpm | lbs/100 | 73 | 72 | 86 | 108 | 111 | 124 | 138 |
| | sq. ft | | | | | | | |
| 300 rpm | lbs/100 | 53 | 53 | 55 | 79 | 77 | 85 | 93 |
| | sq. ft | | | | | | | |
| 200 rpm | lbs/100 | 42 | 45 | 45 | 66 | 61 | 68 | 73 |
| | sq. ft | | | | | | | |
| 100 rpm | lbs/100 | 29 | 32 | 31 | 44 | 42 | 45 | 50 |
| | sq. ft | | | | | | | |
| 6 rpm | lbs/100 | 10.7 | 13.0 | 13.2 | 13.1 | 11.9 | 12.1 | 12.6 |
| | sq. ft | | | | | | | |
| 3 rpm | lbs/100 | 9.3 | 10.2 | 10.0 | 10.3 | 9.7 | 9.9 | 10.3 |
| | sq. ft | | | | | | | |

| | | | | | | | |
|---|---|---|---|---|---|---|---|
| Adherence 100° C. | 0.5 | 3 | 2.5 | 0.5 | 2 | 2.5-3 | 2-2.5 |

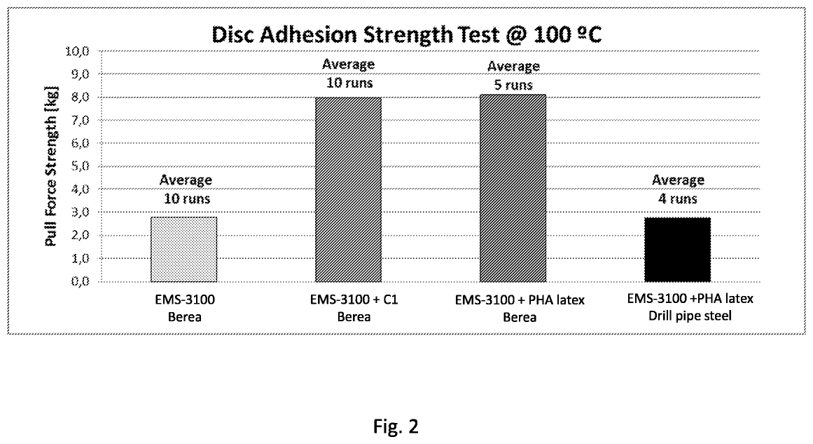

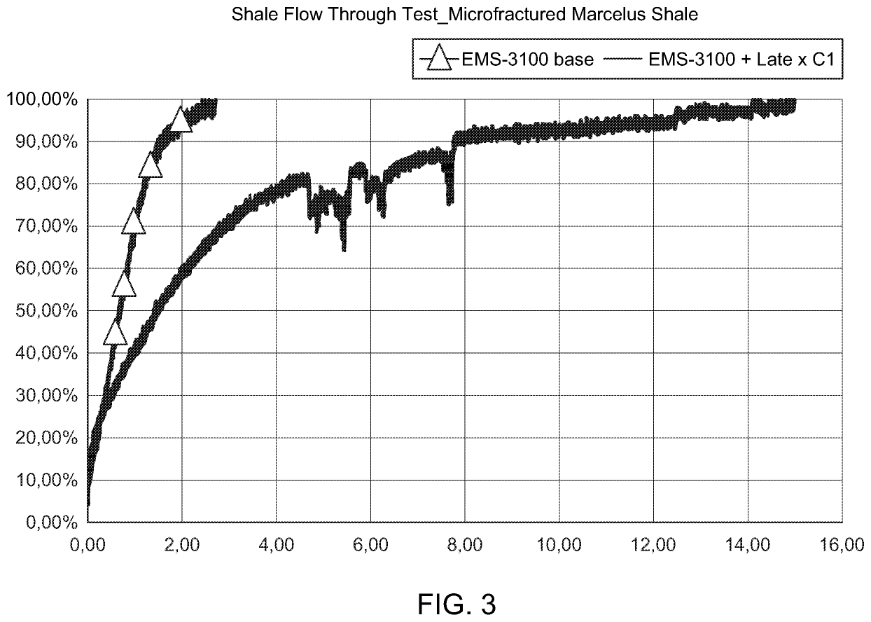

As seen in Table 5, EMS-3100 mixed with latex C1 meets the acceptance criteria for technical performance with respect to viscosity, fluid loss control, filter cake adherence, trapped air, cutting hardness and accretion potential in the temperature range from 25° C. to 100° C. In addition, it was observed that hot rolling up to 100° C. does not have a negative effect on the adhesive properties. FIGS. 2 and 3 show DAST results and SMT results, respectively, performed on EMS-3100 in the presence and absence of a latex polymer.

To further characterize the technical performance, static sag tests and contamination tests were included in the test matrix. The standard formulation based on 1.2 s.g. NaCl has unacceptable high separation and sag. By reducing the NaCl concentration in the brine, the sag is improved and considered to be very high performance. It was observed that for the solids contaminated fluid (HPC), the latex concentration may be increased to 150 g/l to achieve sufficient filter cake adhesion. For lower mud weights ranging from 1.4 s.g. to 1.2 s.g. sufficient adhesion is obtained with 100 g/l latex for the HPC contaminated fluids. The final fluid formulation optimized for an acceptable performance with respect to viscosity, trapped air, fluid loss, filter cake, adhesion, inhibition, static sag and contamination is shown below in Table 6.

TABLE 6
Final EMS-3100 fluid formulation with
recommended concentration of latex C1

| | | Conc. |
|---|---|---|
| Product | Function | g/l |
| NaCl brine 1.10 sg | Base fluid | 680 |
| Kla-Hib NS | Inhibitor | 80 |
| Trol FL | FL agent | 7 |
| Duovis Plus NS | Viscosifier | 2.5 |
| Barite | Weight material | 557 |
| EMI-2223 | Anti-accrete | 73 |
| Latex C1 | Sealant | 100 |

Next, a polyhydroxyalkanoate (PHA) latex polymer was mixed with the water based fluid system EMS-3100. Experimental results indicate that the PHA latex polymer is less efficient as fluid loss additive compared to latex C1, but obtains the same filter cake adherence with proper fluid loss additive package. Like the styrene/acrylate latex, the PHA latex polymer may also need a coalescing agent to obtain acceptable filter cake adhesion at lower temperatures, as seen below in Table 7. At 80° C. and above no coalescing agent is needed to achieve acceptable filter cake adhesion.

TABLE 7
PHA latex with coalescing agent, triacetin, in EMS-3100 AHR at various temperatures

| | HR & Test Temperature | | | | | | | | | |
|---|---|---|---|---|---|---|---|---|---|---|
| | | AHR 40° C. | | | | AHR 60° C. | | | AHR 80° C. | AHR 100° C. |
| Trol Fl | g/l | 7.5 | | | | 7.5 | | | 15 | 15 |
| Lo-Floss | g/l | 7.5 | | | | 7.5 | | | 7.5 | 7.5 |
| Triacetin | g/l | — | 10 | 25 | 50 | — | 25 | 50 | — | — |
| pH | | 8.8 | 7.6 | 7.3 | 7.3 | 8.8 | 6.9 | 6.9 | 8.3 | 7.1 |
| Viscosity | | 13 | 13 | 13 | 13 | 11 | 11 | 10 | 10 | 10 |
| profile: 600/3 | | | | | | | | | | |
| rpm ratio | | | | | | | | | | |
| HTHP fl. l. | ml | 5 | 5.5 | 5 | 5 | 10 | 9 | 11 | 7 | 7 |
| Adherence AHR | | Low | Low | Med/ | Med/ | Low | Med/ | Med/ | Med/ | Med/ |
| 60 g PHA | | | | Strong | Strong | | Strong | Strong | Strong | Strong |
| Adherence AHR | | Low/ | Low/ | Med/ | Med/ | Med | Med/ | Med/ | Med/ | Med/ |
| 100 g PHA | | Med | Med | Strong | Strong | | Strong | Strong | Strong | Strong |

Various concentrations of PHA latex polymer and dibutylsebacate, as a coalescing agent, have been evaluated with respect to the filter cake adherence at various temperatures to minimize concentration and product cost. To obtain acceptable adhesion in a 1.5 s.g. EMS-3100 fluid for the complete temperature range, the minimum concentration is 30 g/l PHA latex and 25 g/l dibutylsebacate, as shown below in Table 8.

TABLE 8
PHA latex with dibutylsebacate at various concentrations in EMS-3100 AHR

| PHA latex | Dibutylsebacate | AHR | AHR | AHR | AHR | AHR |
|---|---|---|---|---|---|---|
| g/l | g/l | 20° C. | 40° C. | 60° C. | 80° C. | 100° C. |
| 100 | — | | Low/Med | Medium | Med/Strong | Med/Strong |
| 100 | 25 | | Med/Strong | Med/Strong | | |
| 30 | 25 | Med/Strong | Med/Strong | Med/Strong | Med/Strong | Med/Strong |
| 30 | 10 | | Low/Med | | | |
| 20 | 25 | | Medium | | | |

Complete testing of 1.5 sg EMS-3100 with 30 g/l PHA latex and 25 g/l dibutylsebacate proves that this fluid meets performance criteria with respect to viscosity, pH, trapped air, fluid loss control, filter cake adhesion, recovery and cutting hardness in the desired temperature range. However, the test matrix also revealed issues with static sag at 80° C., reduced filter cake adhesion for the HPC, seawater and cement contaminated samples and accretion issues at 80° C. Further testing to solve these issues are described in the sections below.

Contamination Issues

The HPC contaminated sample exhibited a lower filter cake adherence compared to the seawater and cement contaminated samples. The optimization with respect to adherence has been performed on the HPC contaminated sample as it is a worst case scenario. A comparison of filter cake adherence when various coalescing agents are used shows that the dibutylsebacate is not as efficient as tributyrin with respect to filter cake adherence of HPC contaminated sample (see Table 9). The HPC contaminated sample meets adhesion specification by increasing the PHA latex polymer to 60 g/l and the tributyrin to 40 g/l.

TABLE 9
Filter cake adherence of HPC contaminated sample at 40° C. BHR

| | | | Bis | |
|---|---|---|---|---|
| PHA | | | (2-ethylhexyl) | |
| latex | Dibutylsebacate | Tributyrin | adipate | Adherence |
| g/l | g/l | g/l | g/l | 40° C. |
| 60 | 40 | | | Medium |
| 60 | | 25 | | Medium |
| 60 | | 40 | | Medium/Strong |
| 60 | | | 40 | Low/Medium |

The HPC contamination test procedure is a worst case scenario as the solid is added to the drilling fluid without subsequent dilution to specified MW. The selected 1.5 s.g. MW is the maximum MW for the potential applications. Adding 100 g/l HPC to a 1.50 s.g. fluid increases the MW to 1.54. By diluting the HPC contaminated fluid to MW 1.50 s.g. the concentration of tributyrin is reduced from 40 g/l to 25 g/l, as shown below in Table 10. For MW at 1.4 s.g. and lower, solids contaminations up to 200 g/l does not negatively affect the filter cake adherence. To summarize, 30 g/l PHA latex polymer and 25 g/l tributyrin may obtain acceptable filter cake adhesion with standard HPC concentration for the majority of the potential applications.

TABLE 10
Filter cake adherence of HPC contaminated fluids
with respect to MW

| | | PHA | | Fluid | |
|---|---|---|---|---|---|
| | HPC | latex | Tributyrin | loss | Adherence |
| Fluid | g/l | g/l | g/l | ml | 40° C. |
| 1.54 s.g. | 100 | 60 | 40 | 5.5 | Medium/Strong |
| 1.50 s.g. | 100 | 60 | 25 | 4 | Medium/Strong |
| | 200 | 60 | 25 | 4 | Medium/Strong |
| 1.4 s.g. | 100 | 30 | 25 | 4.5 | Medium/Strong |
| | 200 | 30 | 25 | 3 | Medium/Strong |

Based on the testing, tributyrin (tributyl ester of glycerol) is the optimum coalescing agent. In addition, tributyrin is feasible economically, as well as environmentally acceptable.

Sag Issues at 80° C.

Compared to the EMS-3100 base fluid, the addition of PHA latex polymer and tributyrin does not have a negative effect with respect to sag. Table 11, below, shows results of one day static sag at 80° C.

TABLE 11
1 day static sag at 80° C.

| 1.5 s.g. | | | |
|---|---|---|---|
| EMS-3100 | Base | PHA | PHA latex + |
| at 80° C. | fluid | latex | Tributyrin |
| PHA latex | — | 30 g/l | 30 g/l |
| Tributyrin | — | — | 25 g/l |
| 600/3 rpm AHR | 112/11 | 78/10 | 81/10 |
| ΔMW 1 day static | 0.55 | 0.64 | 0.38 |

Accretion Issues at 80° C.

For a high performance water based mud, HPWBM, the accretion potential may be less than 20% and EMS-3100 fluid with 30 g/l PHA latex may meet the target up to 60° C. However, at 80° C. the accretion potential increases to unacceptable 47% and the fluid formulation may be optimized to meet accretion target, as seen in Table 12. Replacing anti-accrete EMI-2223 with EMI-1913 improves accretion to 32%, but decreases filter cake adherence. Addition of encapsulator (EMI-3172) improves accretion to specification, but decreases filter cake adherence. By replacing the Kla-Hib NS inhibitor with EMI-3192 and adding both PHA latex and tributyrin, both accretion and filter cake adherence target are met.

TABLE 12
Optimizing EMS-3100 with respect to accretion and adherence at 80° C.

| | | EMS-3100 | EMS-3100 + | New | | | |
|---|---|---|---|---|---|---|---|
| Product | Function | No PHA latex | PHA latex | anti-accrete | Encapsulator | New Inhibitor | |
| Kla-Hib NS | Inhibitor | 80 g/l | 80 g/l | 80 g/l | 80 g/l | — | — |
| EMI-3192 | Inhibitor | — | — | — | — | 40 g/l | 40 g/l |
| EMI-2223 | Anti-accrete | 73 g/l | 73 g/l | — | 73 g/l | 73 g/l | 73 g/l |
| EMI-1913 | Anti-accrete | — | — | 25 g/l | — | — | — |
| EMI-3172 | Encapsulator | — | — | — | 8.6 g/l | — | — |
| PHA latex | Seal | — | 30 g/l | 30 g/l | 30 g/l | 30 g/l | 30 g/l |
| Tributyrin | Coalescing | — | — | — | — | — | 25 g/l |
| Accretion | | 28% | 47% | 32% | 19% | 19% | 15% |
| Adherence BHR | | No/Low | Med./Strong | Low | Low | Med./Strong | Med./Strong |
| Adherence AHR | | No/Low | Med./Strong | Low | Low | Med. | Med./Strong |

Advantageously, embodiments of the present disclosure may provide wellbore fluids and methods of using such fluids that include an aqueous base fluid, a plurality of latex particles and a coalescing agent present in the fluid in an amount effective to have an effect on decreasing the activation temperature of the latex. The latex polymers may provide reduction of losses, blockage of fluid invasion into micro-fractured shale, strong adhesion of the filter cake to the formation and increased mechanical strength of the filter cake. In addition, acceptance criteria for a high-performance water based drilling fluid are met. The addition of a coalescing agent to a latex polymer advantageously enables activation down to ambient temperatures. However, a downhole heat activation tool may not be desired. The latex chemistry as described herein may be functional in water based drilling fluids.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

What is claimed:

1. A wellbore fluid, comprising:
an aqueous base fluid;
a plurality of latex particles; and
a coalescing agent present in the fluid in an amount effective to have an effect on decreasing the activation temperature of the latex.

2. The wellbore fluid of claim 1, wherein the latex is present in the wellbore fluid in a concentration of at least 100 g/l.

3. The wellbore fluid of claim 1, wherein the latex particles have a particle size distribution d₅₀ of less than 1500μ.

4. The wellbore fluid of claim 1, wherein the latex is prepared from one or more polymers or selected from a group consisting of alkyl-acrylate-co-acetate, styrene acrylate amine terpolymer, styrene-co-acrylate, styrene acrylate methacrylate terpolymer, styrene-co-amine polymer, polyhydroxyalkanoate, natural latex, starches, and polyvinyl acetate.

5. The wellbore fluid of claim 1, wherein the latex activates and adheres at temperatures ranging from about 25° C. to about 100° C. in the absence of a heat activation tool.

6. The wellbore fluid of claim 1, wherein the coalescing agent is present in the wellbore fluid in a concentration that ranges from about 1 g/l to about 30 g/l.

7. The wellbore fluid of claim 1, wherein the coalescing agent is selected from the group of polyols and polyol esters.

8. The wellbore fluid of claim 7, wherein the polyol esters have a molecular weight up to 12,000.

9. The wellbore fluid of claim 1, wherein the wellbore fluid is a drilling fluid.

10. The wellbore fluid of claim 1, wherein the wellbore fluid further comprises a plurality of fibers.

11. A method, comprising:
emplacing a wellbore fluid into a wellbore through an earthen formation, the wellbore fluid comprising:
an aqueous base fluid;
a plurality of latex particles; and
a coalescing agent present in the fluid in an amount effective to have an effect on decreasing the activation temperature of the latex.

12. The wellbore fluid of claim 11, wherein the latex is present in the wellbore fluid in a concentration of at least 100 g/l.

13. The wellbore fluid of claim 11, wherein the latex particles have a particle size distribution d₅₀ of less than 1500μ.

14. The wellbore fluid of claim 11, wherein the latex is prepared from one or more polymers or selected from a group consisting of alkyl-acrylate-co-acetate, styrene acrylate amine terpolymer, styrene-co-acrylate, styrene acrylate methacrylate terpolymer, styrene-co-amine polymer, polyhydroxyalkanoate, natural latex, starches, and polyvinyl acetate.

15. The wellbore fluid of claim 11, wherein the latex activates and adheres at temperatures ranging from about 25° C. to about 100° C. in the absence of a heat activation tool.

16. The wellbore fluid of claim 11, wherein the latex achieves low accretion values at ambient and elevated temperatures.

17. The wellbore fluid of claim 11, wherein the coalescing agent is present in the wellbore fluid in a concentration that ranges from about 1 g/1 to about 30 g/l.

18. The wellbore fluid of claim 11, wherein the coalescing agent is selected from the group of polyols and polyol esters having a molecular weight of up to 12,000.

19. The wellbore fluid of claim 11, wherein the wellbore fluid further comprises a plurality of fibers.

20. The wellbore fluid of claim 11, wherein the wellbore fluid is a drilling fluid.

21. The method of claim 11, further comprising forming a filter cake in the wellbore.
